(19) United States
(12) Patent Application Publication
(10) Pub. No.: US 2014/0365030 A1
(43) Pub. Date: Dec. 11, 2014

(54) DRIVING BEHAVIOUR MONITORING SYSTEMS

(71) Applicant: Wunelli Limited, Hampshire (GB)

(72) Inventor: Paul Rowan STACY, Hampshire (GB)

(21) Appl. No.: 14/300,922

(22) Filed: Jun. 10, 2014

(30) Foreign Application Priority Data
Jun. 10, 2013 (GB) 1310301.5

(51) Int. Cl. G08G 1/00

(52) U.S. Cl. CPC G08G 1/00
USPC 701/1

(57) ABSTRACT

A device comprising a data processor configured to receive one or more indicators of movement, and determine if the one or more indicators of movement correspond to a frame of reference of a moving vehicle, and the device comprising a driving behaviour functionality configured to monitor driving behaviour, and an activator in communication with the data processor and the driving behaviour monitoring functionality, the activator comprising an auto-start functionality responsive to a determination by the data processor, of the frame of reference of the vehicle.

### CROSS-REFERENCE TO RELATED APPLICATIONS

This application claims priority from UK Patent Application No. 1310301.5 filed Jun. 10, 2013 in the UK Intellectual Property Office by the inventor herein, the specifications of which are incorporated herein by reference in their entireties.

### TECHNICAL FIELD

The present invention relates generally to driving behaviour monitoring systems.

### BACKGROUND

It can be desirable to monitor how a vehicle is used in order to be able to use the vehicle usage data for a supplementary purpose. One use of such vehicle usage data is to be able to calculate, or adjust, a vehicle insurance premium in dependence upon how the vehicle is being used. Another use of such vehicle usage data would be to provide feedback to the driver on how they are driving, for example, how safely they are driving. We seek to provide improvements in relation to such systems.

### SUMMARY

According to the first aspect of the invention there is provided a driving behaviour monitoring device comprising an activator, wherein the device comprises a data processor, and the activator comprising an auto-start functionality implemented by the data processor, and said auto-start functionality arranged to control activation of driving behaviour monitoring functionality of the device and the processor is arranged to determine if the device is in the frame of reference of a moving vehicle, and wherein, if the processor so determines, the monitoring functionality is activated. The invention may be viewed as an activator for a driving behaviour monitoring device.

Preferably, when the monitoring functionality is activated positional data of the vehicle, or data derived from the positional data, is recorded and/or output.

The device may comprise an installed software application which is operative to implement the auto-start functionality. On determination that the vehicle is in the frame of reference of a moving vehicle, the activator may be configured to generate an internal signal or indicator which causes the data processor to commence the monitoring functionality.

The device preferably comprises a navigational positioning module. The navigational positioning module is preferably arranged to communicate with a satellite positioning system, such as GPS, for example.

The device may comprise a cellular mobile telecommunications device or telephone.

The device may be enabled to determine the speed of the vehicle and if the speed is below a predetermined speed, then the processor arranged to deactivate the monitoring.

The device may be arranged to determine the presence of a short range air interface communications device installed in the vehicle. The device may be arranged to detect a polling signal emitted by the communications device. The communications device may be a Bluetooth® device, for example.

The device may be arranged to determine if said device is in a vehicle which is moving by using geo-fencing monitoring of the device in relation to cellular telecommunication tower location. Preferably, the monitoring is activated if it is determined that the identity of cellular changes. The device may be arranged to monitor an identifier of a cellular telecommunications tower. It will be appreciated that by “tower” we include a cellular communications transceiver station which services a particular cell.

The device may be arranged to measure changes in acceleration experienced by the device. The device preferably determines sequences of changes in acceleration experienced by the device, and compares the sequences to stored patterns of acceleration. The device is preferably arranged to determine whether there is sufficient similarity between the measured acceleration sequence and the stored acceleration pattern and if it is determined that there is a sufficient similarity to then commence monitoring. The stored acceleration pattern or patterns is/are indicative of the vehicle moving/being driven.

The device may be arranged to sample sound in the location/environment of the device. The device is preferably arranged to compare the recorded sound sample with pre-stored data indicative of sound within a driven/moving vehicle. If the device determines that there is sufficient similarity between the recorded sound sample and the pre-recorded data, the device is operative to activate the monitoring.

The device may be arranged to communicate with an onboard diagnostics module of the vehicle and to obtain vehicle usage data therefrom. The onboard diagnostics module may be arranged to transmit vehicle ignition-on and vehicle ignition-off events and data from the vehicle's management system.

According to a second aspect of the invention there is provided a method of controlling a driving behaviour monitor, the method may comprise automatically activating driving behaviour monitoring in response to determining if the monitor is in the frame of reference of moving vehicle. The method may be viewed as automatically controlling activation of a driving behaviour monitoring device.

The method may comprise using data sensed by the device within the local environment of the device, to determine if said device is in the frame of reference of a vehicle. The device may comprise one or more sensors arranged to send signals to the data processor.

According to a third aspect of the invention there are provided machine-readable wishmotions which, when executed by a data processor of a driving behaviour monitor, cause the data processor to automatically activate driving behaviour monitoring in response determination that the device is in the frame of reference of a vehicle.

A further aspect of the invention relates to machine-readable instructions arranged, when executed by a data processor, to implement the auto-start functionality of the first aspect of the invention. The instructions may be realised as a software product. The software product may be suitable for installation onto a telecommunications device.

### BRIEF DESCRIPTION OF THE DRAWINGS

Various embodiments of the invention will now be described, by way of example only, with reference to the accompanying drawings in which:

FIG. 1 is a schematic diagram of a driving behaviour monitoring system,

FIG. 2 is a flow diagram of a first sequence of steps to determine if a driving behaviour monitor is in a moving vehicle,

FIG. 3 is a flow diagram of a second sequence of steps to determine if a driving behaviour monitor is in a moving vehicle,

FIG. 4 is a flow diagram of a third sequence of steps to determine if a driving behaviour monitor is in a moving vehicle, and

FIG. 5 is a fourth sequence of steps to determine if a driving behaviour monitor is in a moving vehicle.

### DETAILED DESCRIPTION

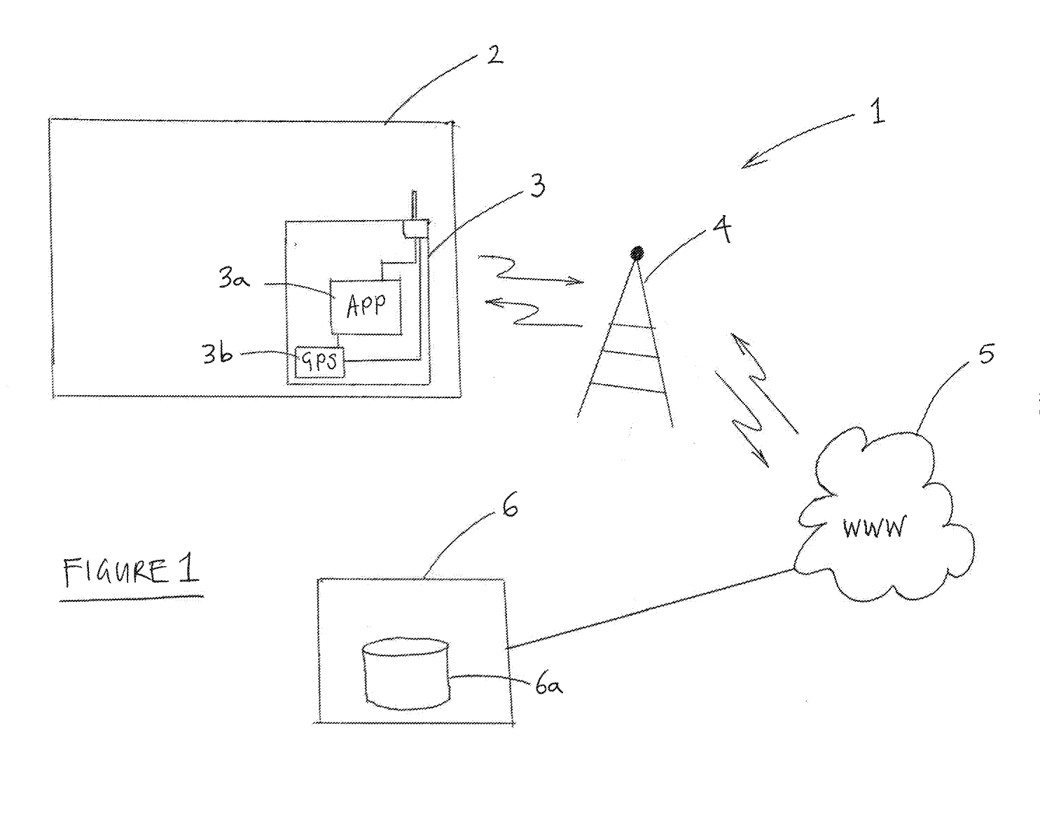

Reference is made initially to FIG. 1 which shows a driving behaviour monitoring system 1, which comprises a cellular mobile communications device 3, and a driving behaviour server 6. Broadly, the telephone 3 is provided with an application 3a which is operative, when executed by a data processor of the telephone, to monitor the driving behaviour of the user of the telephone whilst driving a vehicle 2. The application 3a receives data indicative of the driver's speed, acceleration, position via a navigational positional module 3b, such as Global Positioning System (GPS). The application also receives data from the vehicle 2, such as the vehicle's on board diagnostics module, which generates vehicle usage data. The telephone is operative to send the data, via a telecommunications network, 4 and 5, to a server 6, where the data is processed to determine a driving behaviour score. Driving scores are caused to be stored in a database 6a.

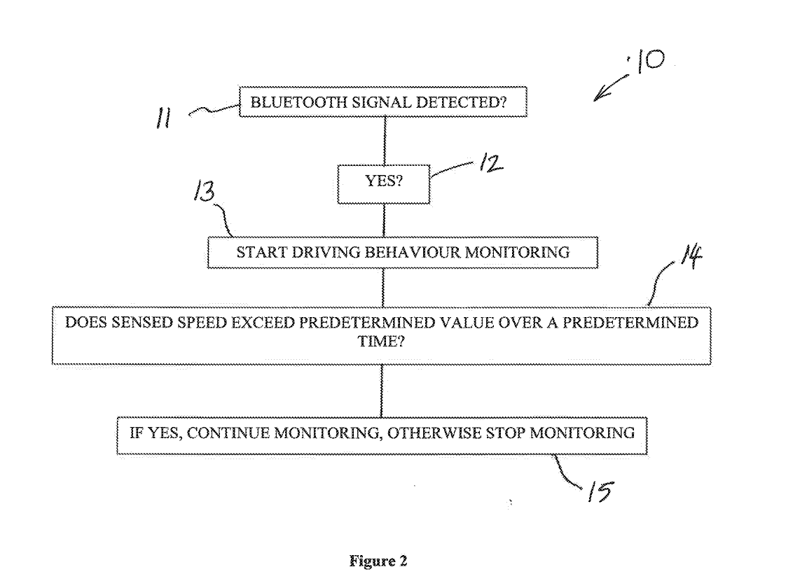

The application 3a is arranged to implement an auto-start or activation functionality on the data processor of the device wherein the device determines whether it is the frame of reference of a moving vehicle, as will be described with reference to FIGS. 2, 3 and 4. Conveniently, the commencement of the driving behaviour monitoring starts without the user needing to take any positive action. As will be described below, this can be achieved in various ways.

A first way in which the auto-start functionality operates, is to determine whether it can detect the presence of a short-range air interface communications device, such as a Bluetooth® interface. Such an interface, in a vehicle, may be in the form of an in-car phone kit. The device is caused to determine whether it can detect a polling signal issued by the interface. If such a signal is detected, it determines that a Bluetooth® interface is in close proximity. As shown by steps 11, 12 and 13, when such an interface is detected, driving behaviour monitoring is started. In order to ensure that the vehicle is moving, and as shown at steps 14 and 15, using the navigational positioning functionality of the device 1, it is determined whether the vehicles speed exceeds a predetermined road speed over a predetermined time. If that criteria is met, monitoring of driving behaviour is caused to continue. It will be appreciated that steps 14 and 15 may be repeated periodically.

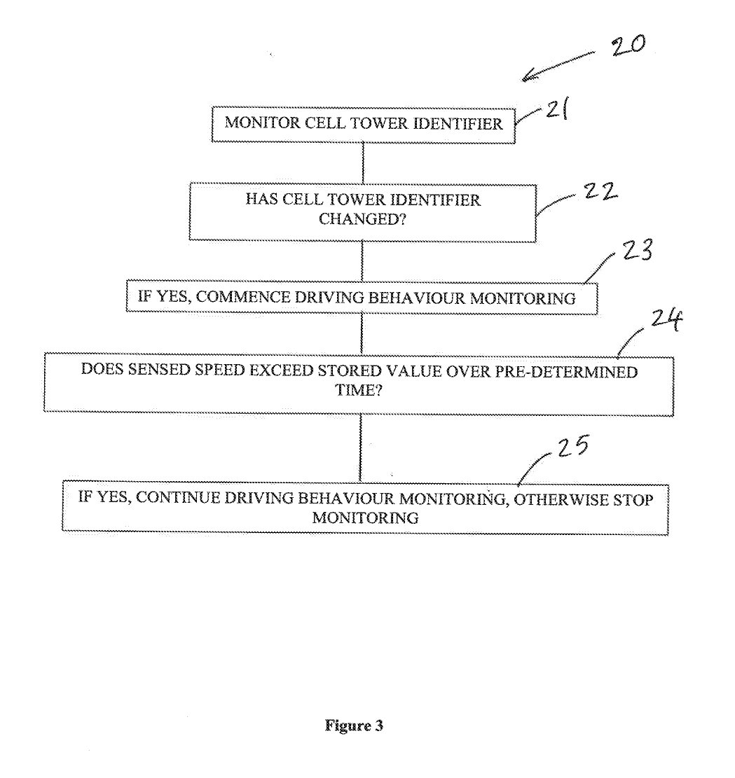

A second manner in which the device 1 can determine whether the vehicle 2 is moving is by way of determining whether the cell tower of mobile telecommunications network has changed, as shown in FIG. 3. As can be seen, the application 3a causes the device to monitor the identity of the local cell tower 4. If it is determined that the identity of the cell tower has changed, this is taken to indicate that the vehicle is moving, as shown in steps 21 to 23. As shown at steps 24 and 25, the device 1 is operative to continue driving behaviour monitoring if the determined road speed exceeds a predetermined value over a predetermined time period.

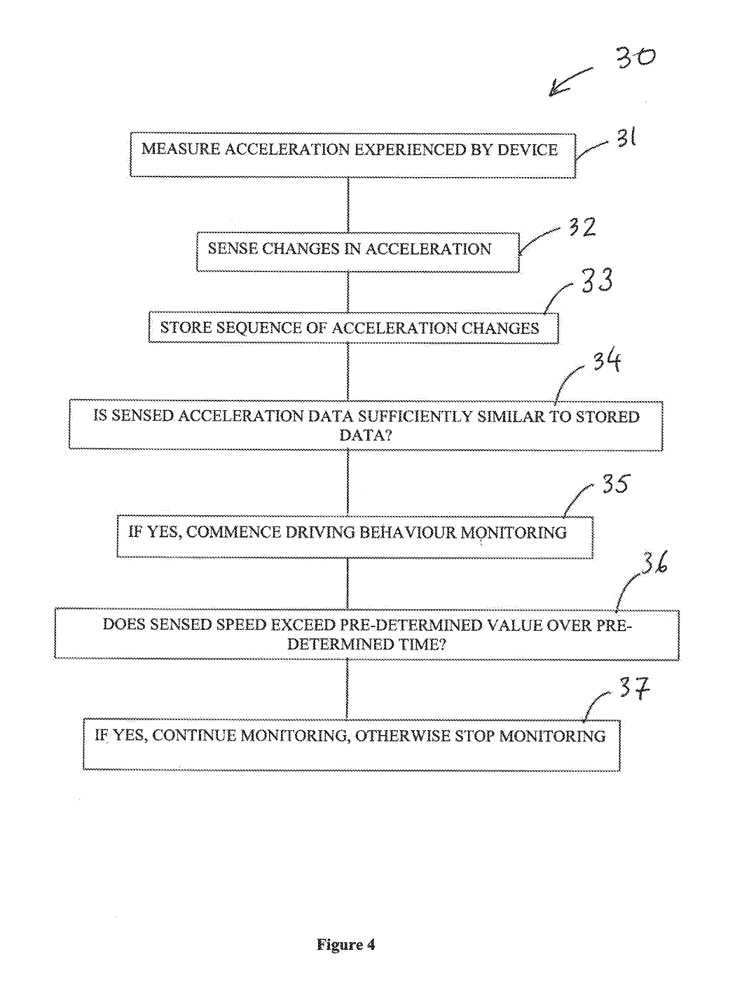

FIG. 4 shows a further way in which the device 1 may determine whether the vehicle is moving. Using the device's built-in accelerometer module (not illustrated) the device 1 can sense changes in acceleration that it experiences, as shown at steps 31 and 32.

The device is operative to store the changes in acceleration and compare the same to stored data which is indicative of the acceleration(s) that would be experienced by the device if it were in the frame of reference of a moving vehicle. Broadly, the application 3a causes the processor of the device to compare the acceleration pattern sensed to that which is stored in the memory of the device. If it is determined that there is sufficient similarity, the application 3a causes the device to commence monitoring of driving behaviour. As shown at steps 36 and 37, if the sensed speed exceeds a predetermined value over a predetermined time, the monitoring is caused to continue.

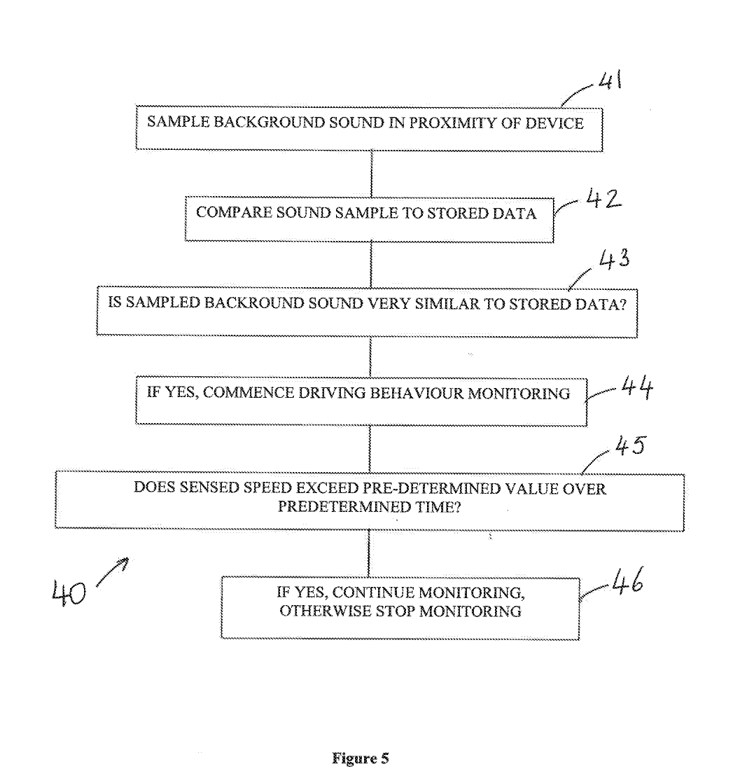

As shown in FIG. 5, the device 1 is arranged to sample background sound in proximity of the device, at step 41. The captured sound sample is then compared to stored data which is indicative of sound that would be heard in a moving vehicle. If there is sufficient similarity between the captured sound and the stored sound, it is determined by the device that the device is in the frame of reference of a moving vehicle. Accordingly, commencement of the driving behaviour monitoring is actioned. If the sensed speed exceeds a predetermined value over a predetermined time, it is determined that the device is in the frame of reference of a moving vehicle, as outlined at steps 45 and 46.

It will be appreciated that the application 3a may be arranged to implement one or a combination of the various ways above to determine that the device is in the frame of reference of a moving vehicle. For example, some or all of the above ways may be implemented, and driving behaviour monitoring is commenced if at least one way results in a positive determination that the vehicle is moving.

1. A device comprising:
a data processor configured to:
receive one or more indicators of movement; and
determine if the one or more indicators of movement correspond to a frame of reference of a moving vehicle;
a driving behaviour monitoring functionality configured to monitor driving behaviour; and
an activator in communication with the data processor and the driving behaviour monitoring functionality, the activator comprising an auto-start functionality configured to control the driving behaviour monitoring functionality responsive to a determination, by the data processor, of the frame of reference of the vehicle.

2. The device of claim 1, wherein the driving behaviour monitoring functionality is activated responsive to positional data of the vehicle, and data derived from the positional data is output.

3. The device of claim 1, wherein the activator comprises an installed software application which is operative to implement the auto-start functionality by the data processor.

4. The device of claim 1, further comprising a navigational positioning module.

5. The device of claim 4, wherein the navigational positioning module is arranged to communicate with a satellite positioning system.

6. The device of claim 1, further comprising a cellular mobile telecommunications device or telephone.

7. The device of claim 1, wherein the activator is configured to determine the speed of the vehicle, and wherein if the speed is above a predetermined speed, the activator activates the driving behaviour monitoring functionality, and wherein if the speed is below a predetermined speed, the activator deactivates the driving behaviour monitoring functionality.

8. The device of claim 1, wherein the processor is configured to determine the presence of a short-range air interface communications device installed in the vehicle.

9. The device of claim 1, wherein the is activator configured to determine if the device is in a vehicle which is moving by using geo-fencing monitoring of the device in relation to cellular telecommunication tower location.

10. The device of claim 1, wherein the activator is configured to measure changes in acceleration experienced by the device.

11. The device of claim 10, wherein the data processor is further configured to determine a sequence of changes in acceleration experienced by the device, and is further configured to compare the sequences to stored patterns of acceleration.

12. The device of claim 10, wherein the data processor is further configured to determine whether there is sufficient similarity between the measured acceleration sequence and the stored acceleration pattern and, responsive to a determination that there is a sufficient similarity, activating the driving behaviour monitoring functionality.

13. The device of claim 1, wherein the activator is configured to sample location/environment sound.

14. The device of claim 13, wherein the activator is configured to compare sampled sound with pre-stored data indicative of sound within a moving vehicle, and responsive to a determination that there is sufficient similarity between the recorded sound sample and the pre-recorded data, activating the driving behaviour monitoring functionality.

15. The device of claim 1, wherein the activator is configured to communicate with an onboard diagnostics module associated with the vehicle and to obtain vehicle usage data therefrom.

16. The device of claim 15 in which the onboard diagnostics module is configured to transmit vehicle ignition-on and vehicle ignition-off events and data from the vehicle's management system.

17. A method of controlling a driving behaviour monitor comprising:
automatically activating driving behaviour monitoring in response to determining if a device is in a frame of reference of a moving vehicle.

18. The method of claim 17, further comprising using data sensed by the device within the local environment of the device, to determine if said device is in the frame of reference of a vehicle.

19. Machine-readable instructions for an activator of a driving behaviour monitoring device which, when executed by a data processor of a driving behaviour monitor, cause the data processor to automatically activate driving behaviour monitoring in response to determination that the device is in the frame of reference of a vehicle.
